(19) United States
(12) Patent Application Publication
(10) Pub. No.: US 2017/0213249 A1
(43) Pub. Date: Jul. 27, 2017

(54) INFORMATION DISPLAY METHOD AND INFORMATION DISPLAY DEVICE

(71) Applicant: toor Inc., Onuma-gun, Fukushima (JP)

(72) Inventors: Yoshio TAKAEDA, Fukushima (JP); Tetsuya KANADA, Fukushima (JP)

(21) Appl. No.: 15/308,621

(22) PCT Filed: Sep. 29, 2015
(86) PCT No.: PCT/JP2015/077441

§ 371 Date: Nov. 3, 2016

(30) Foreign Application Priority Data
Oct. 15, 2014 (JP) 2014-210363

(51) Int. Cl. G06Q 30/02; G06F 17/30

(52) U.S. Cl. CPC G06Q 30/0256; G06F 17/30994

(57) ABSTRACT

An object of the present invention is to display an advertisement so that relevance to a search term is clarified in an advertisement display for a search service. An information display device 10 according to the present invention includes: a map creation unit 121 configured to arrange, on a surface, an information population including arbitrary items of information based on closeness of contents of the items of information; an additional information arrangement unit 122 configured to, responsive to acquiring additional information that is different from the information population including the arbitrary items of information, arrange the additional information in the vicinity of an item of information having contents close to those of the additional information among the items of information arranged on the surface; a display unit 123 configured to display a map in which points representing the respective items of information included in the information population and a point representing the additional information are arranged on the surface; and an additional information display unit 124 configured to, responsive to the point representing the additional information being selected on the map, display the additional information.

### BACKGROUND

1. Field of the Disclosure

The present disclosure relates to an information display method and an information display device for displaying additional information that is different from items of information constituting a map on the map that displays closeness of contents between the items of information.

2. Discussion of the Background Art

A service for searching a large number of documents for documents having contents close to each other has been provided (for example, refer to Patent Literature 1). Patent Literature 1 plots points of the respective documents so that the similar documents are arranged close to each other. Consequently, a map representing the similarity between the respective documents can be created.

In addition, a search service for listing locations of websites related to an input term in response to the input of the term has been provided. This search service displays an advertisement related to the input term together with a list of the locations of the websites.

### CITATION LIST

### Patent Literature

Patent Literature 1: WO 2008/143116 A

### SUMMARY

In Patent Literature 1, since a positional relation in the map varies in accordance with an information population from which the map is created, the map itself is changed in accordance with contents of additional information when the additional information that is different from the information population is included.

It has been difficult for the advertisement display in the search service to precisely display an advertisement of interest to a user of the search service because the number of input words is so small that contents which the user wants to search for cannot be fully grasped.

An object of the present disclosure is to display an advertisement so that relevance between a search result and additional information is clarified in an advertisement display for a search service.

### Solution to Problem

In order to achieve the above-mentioned object, the disclosure of the present application maps items of information related to a search term based on closeness of contents between the items of information, and plots an advertisement on the map.

More specifically, in an information display method according to the present disclosure, a computer executes, in order: a map creation procedure of arranging, on a surface, an information population including arbitrary items of information based on closeness of contents of the items of information; an additional information arrangement procedure of, responsive to acquiring additional information that is different from the information population including the arbitrary items of information, selecting, from the information population, a plurality of items of information having contents close to those of the additional information, calculating, from coordinates of the plurality of items of information on the surface, coordinates of the additional information on the surface based on closeness of the contents between the additional information and the plurality of items of information, and arranging the additional information at a position of the coordinates of the additional information on the surface; a display procedure of displaying a map in which points representing the respective items of information included in the information population and a point representing the additional information are arranged on the surface; and an additional information display procedure of, responsive to the point representing the additional information being selected on the map displayed in the display procedure, displaying the additional information.

In the information display method according to the present disclosure, information related to the additional information may be simultaneously displayed when the additional information is displayed in the additional information display procedure.

More specifically, an information display device according to the present disclosure includes: a map creation unit configured to arrange, on a surface, an information population including arbitrary items of information based on closeness of contents of the items of information; an additional information arrangement unit configured to, responsive to acquiring additional information that is different from the information population including the arbitrary items of information, select, from the information population, a plurality of items of information having contents close to those of the additional information, calculate, from coordinates of the plurality of items of information on the surface, coordinates of the additional information on the surface based on closeness of the contents between the additional information and the plurality of items of information, and arrange the additional information at a position of the coordinates of the additional information on the surface; a display unit configured to display a map in which points representing the respective items of information included in the information population and a point representing the additional information are arranged on the surface; and an additional information display unit configured to, responsive to the point representing the additional information being selected on the map, display the additional information.

### Advantageous Effects of Disclosure

According to the present disclosure, in an advertisement display for a search service, an advertisement can be displayed so that relevance between respective items of information, namely, a search result, and advertisement information is clarified.

### BRIEF DESCRIPTION OF THE DRAWINGS

FIG. 1 is a diagram illustrating an exemplary information display system according to an embodiment of the present disclosure.

FIG. 2 is a diagram illustrating an exemplary sequence for the information display system.

FIG. 3 is a diagram illustrating an exemplary arrangement of additional information on a map.

FIG. 4 is a diagram illustrating a third arrangement example of the additional information in an additional information arrangement procedure.

### DETAILED DESCRIPTION OF THE PREFERRED EMBODIMENT

Hereinafter, embodiments of the present disclosure will be described in detail with reference to the drawings. The present disclosure is not limited to the following embodiments. These implementation examples are merely illustrations, and the present disclosure can be implemented in variously changed or modified forms on the basis of the knowledge of a person skilled in the art. In the present description and the drawings, components denoted by the same reference sign represent the components that are identical to each other.

### First Embodiment

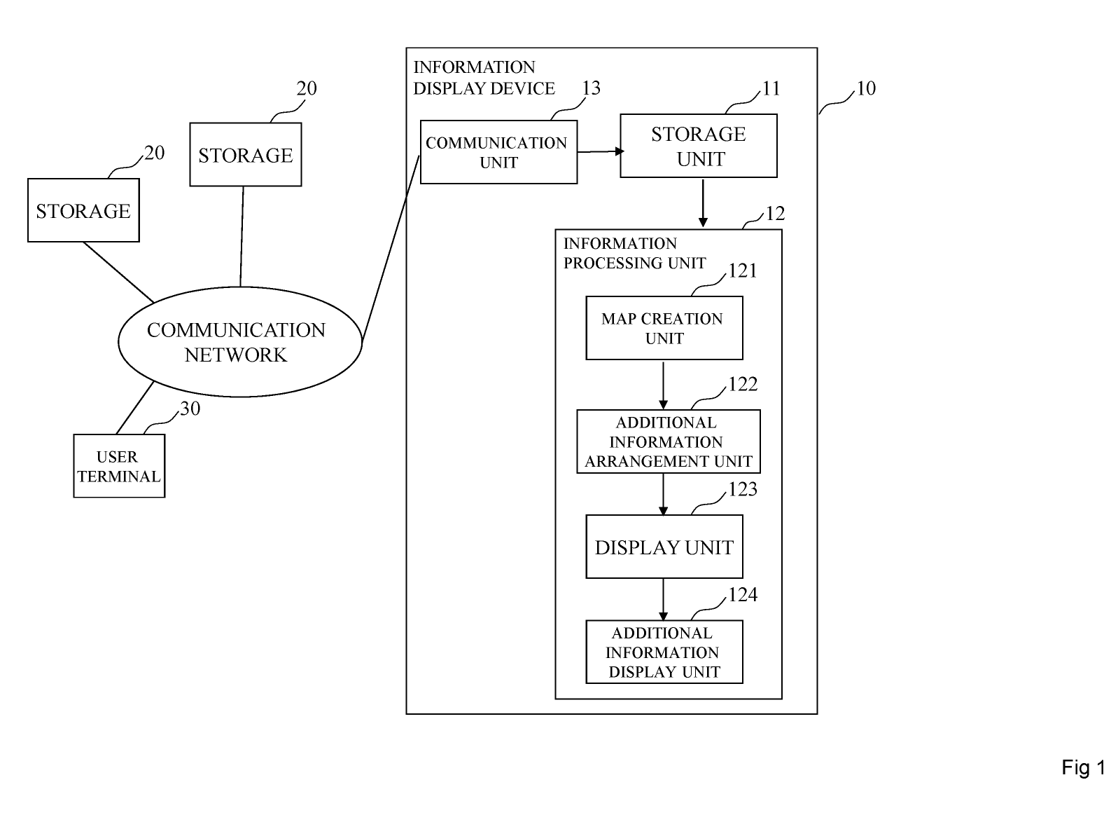

An exemplary information display system according to the present embodiment is illustrated in FIG. 1. The information display system according to the present embodiment is equipped with an information display device 10, a storage 20, and a user terminal 30. Although any number of information display devices 10, storages 20, and user terminals 30 can be employed, the present embodiment describes a case where there are a single information display device 10, two storages 20, and a single user terminal 30.

The storage 20 is an arbitrary storage medium that is accessible from the information display device 10, and holds arbitrary items of information that serve as a search result or an analysis object. As an example, the present embodiment describes a case where the information is a document that serves as an object of a search. The document is an arbitrary medium in which a word can be identified, and image data such as a motion image and a still image and voice data as well as text data are included in the document. The text data include a number or a mark, and a number or a mark is included in a word as well.

The information display device 10 is equipped with a communication unit 13 that sends and receives information to and from the user terminal 30 and the storage 20 via a communication network, and a configuration for creating a map. The configuration for creating the map is equipped with, for example, a map creation unit 121, an additional information arrangement unit 122, a display unit 123, and an additional information display unit 124. The information display device 10 may be realized in such a manner that an information display program is executed by a computer. In this case, an information processing unit 12 executes the information display program stored in a storage unit 11, whereby each component is realized.

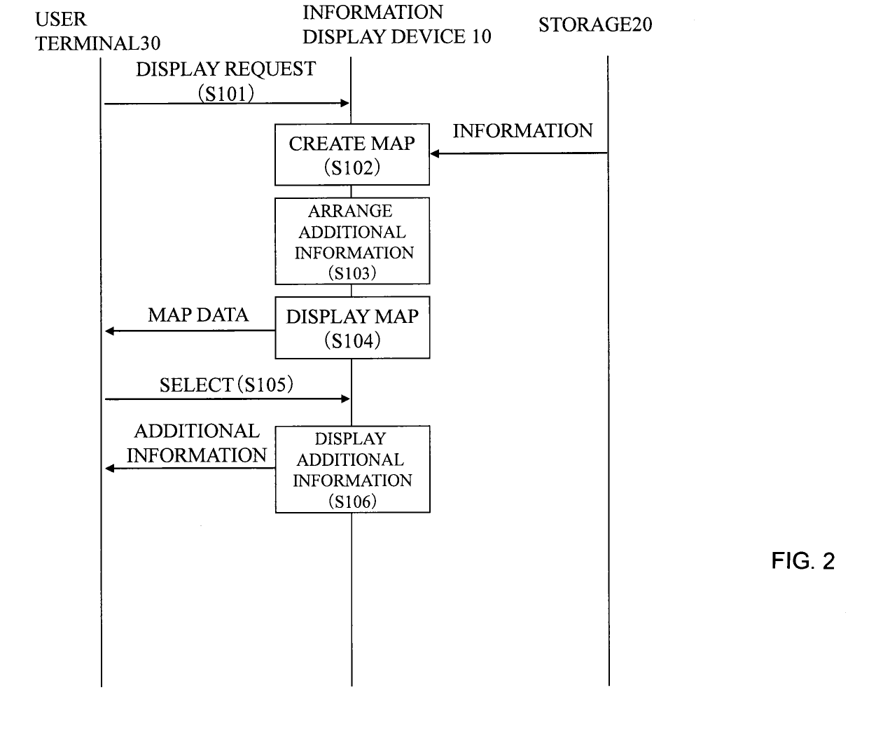

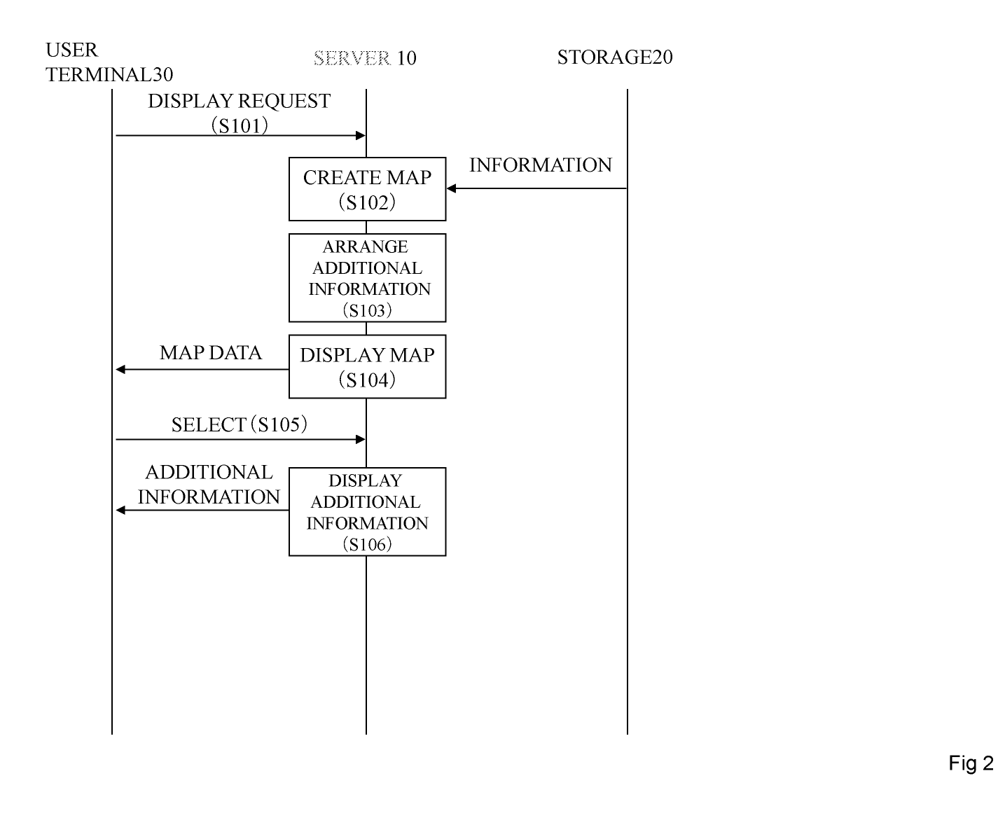

A sequence for the information display system according to the present embodiment is illustrated in FIG. 2. An information display method according to the present embodiment has a map creation procedure, an additional information arrangement procedure, a display procedure, and an additional information display procedure in order. Steps S101 to S102 are executed in the map creation procedure, step S103 is executed in the additional information arrangement procedure, step S104 is executed in the display procedure, and steps S105 to S106 are executed in the additional information display procedure.

The user terminal 30 sends a display request via the communication network (S101). A search term which a user wants to search for is included in the display request. The information display device 10 receives the display request from the user terminal 30, and then executes the map creation procedure. At this time, the map creation unit 121 acquires documents from the storage 20, and creates the requested map using an information population including the acquired arbitrary documents (S102). The creation of the map is performed in such a manner that the documents are arranged on a surface based on closeness of contents of the documents.

When information dᵢ can be represented in a matrix form with respect to an element tⱼ, the information dᵢ can be described by means of a vector space model dᵢ=(t₁, t₂, t₃, . . . ). Assuming that the information dᵢ is a document dᵢ, the element tⱼ is a word tⱼ, and an appearance frequency of the word tⱼ that appears in the document dᵢ is nᵢⱼ, the document dᵢ can be represented by a document vector dᵢ=(nᵢ₁, nᵢ₂, nᵢ₃, . . . ).

$$M = ( \begin{matrix} & {d}_{1} & {d}_{2} & {d}_{3} \\ {t}_{1} & 0 & 2 & 1 \\ {t}_{2} & 1 & 1 & 2 \\ {t}_{1} & 0 & 0 & 3\end{matrix} ) \qquad [ Expression 1 ]$$

In a document set d=Σdᵢ, closeness between the document vectors of the respective documents dᵢ is calculated. Since kinds of used words are similar to each other when the contents of the documents are close to each other, points indicated by the document vectors are arranged close to each other. The closeness between the document vectors is calculated, whereby the closeness of the contents of the documents can be obtained. A distance between the document vectors may be computed, or any computation such as a dot product and a cross product may be used.

In this regard, a word that is used in common by any document does not affect the closeness of the contents of the documents. When the document vector is calculated, therefore, a difference in contribution to the document vector is preferably provided between a word characteristic of each document and other words. For example, weighting is performed using a term frequency inverse document frequency (tfidf) method. Consequently, accuracy of the closeness of the contents of the documents can be improved.

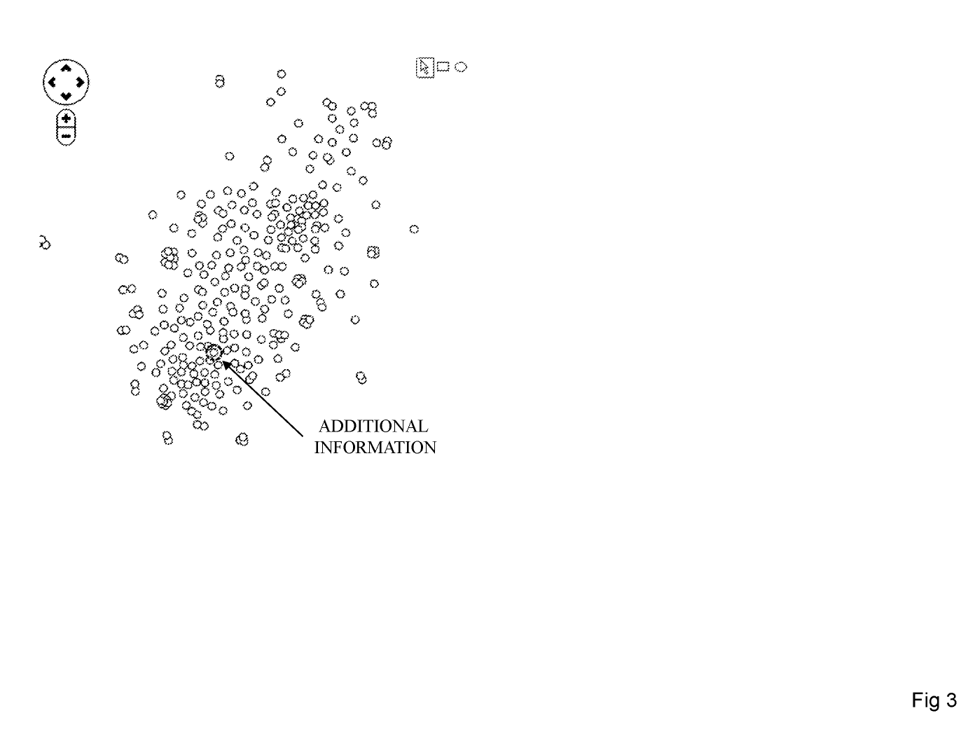

Mapping is performed by means of a mapping algorithm based on the obtained closeness. For example, the points indicated by the document vectors are arranged on the surface. At this time, documents at a long semantic distance from each other are preferably arranged so that accuracy of the distance between the documents on a plane is reduced. Although the arrangement may be performed on the plane as illustrated in FIG. 3, the arrangement may also be performed on a spherical surface.

After the map creation unit 121 creates the map, the additional information arrangement unit 122 executes the additional information arrangement procedure. For example, the additional information arrangement unit 122 acquires additional information, and arranges the additional information in the vicinity of a document having contents close to those of the additional information among the documents arranged on the map (S103). The closeness of the contents can be determined using the vector space model. Consequently, FIG. 3 is an exemplary arrangement on the map. Each point on the map represents each document. The closer the contents of the documents are to each other, the closer the documents are arranged to each other. Then, the additional information is arranged as one of the points of the documents. When there are a plurality of items of additional information, a document having contents close to those of the additional information is specified for each item of additional information among the documents arranged on the map, and the additional information is arranged in the vicinity of the document.

In this regard, the additional information is, for example, information of an advertisement. Since the advertisement is arranged on the map at a position of population information having contents close to those of the advertisement, relevance to the search result can be clarified in an advertisement display for a search service. When there are a plurality of products or services included in the advertisement, each of the products or services is treated as a single item of additional information.

In the display procedure, the display unit 123 displays, on the user terminal 30, the map in which the points representing the respective items of information included in the information population and the point representing the additional information are arranged on the surface (S104). At this time, map data required for displaying the map illustrated in FIG. 3 are sent to the user terminal 30.

When the user terminal 30 selects the point of the additional information from among the points illustrated in FIG. 3 (S105), the information display device 10 executes the additional information display procedure. In the additional information display procedure, the additional information display unit 124 displays, on the user terminal 30, the additional information selected on the map. At this time, information related to the additional information may be simultaneously displayed when the additional information is displayed. For example, contents of the product or service and arbitrary information related to the product or service are included. The arbitrary information related to the product or service includes, for example, information of a provider of the product or service such as a name and a point of contact of the provider.

As described above, the information display system according to the present embodiment can display, on the user terminal 30, the search result in which the items of information related to the search term are mapped in accordance with the contents. At this time, the information display system according to the present embodiment displays the advertisement on the map at a position suitable for the contents of the search result. Therefore, the information display system according to the present embodiment can display the advertisement so that the relevance to the information of the search result is clarified in the advertisement display for the search service. Furthermore, the information display system according to the present embodiment first creates the map using the information population acquired from the storage 20, and then plots the advertisement on the map. Therefore, the information display system according to the present embodiment can stably provide the search service since the map that is formed using the information population is not changed in accordance with the contents of the advertisement.

The additional information is not limited to the advertisement, and may be, for example, a website. Generally, a website of a company includes many web pages (WP) about products or services, an overview of the company, and social activities or the like. In many cases, on the map created in the map creation procedure, there is little point in displaying a front page of the website as the advertisement, and it is effective that a deeply related WP is plotted near the information plot on the map. In order to enable such a map display, it is appropriate that each WP in the website is treated as the additional information and displayed on the map created in the map creation procedure.

In addition to the website, the additional information may be, for example, a product catalog or the like. The product catalog can be divided into products or product categories and processed in the same way. Furthermore, a report, a brochure, and a book can also be processed in the same way.

### Second Embodiment

In the present embodiment, an arrangement example of the additional information in the additional information arrangement procedure will be described. In the additional information arrangement procedure, the additional information is arranged in the vicinity of the population information having the contents close to those of the additional information among the items of information on the map.

### (1) First Arrangement Example

In the present arrangement example, an internally dividing point between top two points that are close in terms of the contents is selected as a plot position of S on a multi-dimensional vector space. For example, the closeness of the contents between the additional information S and the respective items of information dᵢ in the population constituting the map is calculated. Two items of information dx and dy are sorted out in order of the closeness of the contents to the additional information S. Assuming that coordinates (vectors) on the map of the population corresponding to dx and dy are Px and Py, and indexes representing the closeness of the contents to the additional information S are Sx and Sy, coordinates Ps that satisfy the following formula are position coordinates (vector) on the map at which the additional information S should be plotted.

Ps=Px+(Py−Px)*Sx/(Sx+Sy)

where

|Ps−Px|:|Ps−Py|=Sx:Sy (Expression 2)

### (2) Second Arrangement Example

In the present arrangement example, an internally dividing point between top two points that are close in terms of the contents is selected as the plot position of S on the map. For example, the closeness of the contents between the additional information S and the respective items of information dᵢ in the population constituting the map is calculated. An item of information having the contents closest to those of the additional information S is denoted by dx, and a position vector of dx on the map is denoted by Px. A point closest to dx on the map is denoted by dy, and coordinates (vector) of dy are denoted by Py. Assuming that the closeness of the contents between the additional information S and dx is Sx, and the closeness of the contents between the additional information S and dy is Sy, coordinates Ps that satisfy the following formula are position coordinates (vector) on the map at which the additional information S should be plotted.

Ps=Px+(Py−Px)*Sx/(Sx+Sy) (Expression 3)

### (3) Third Arrangement Example

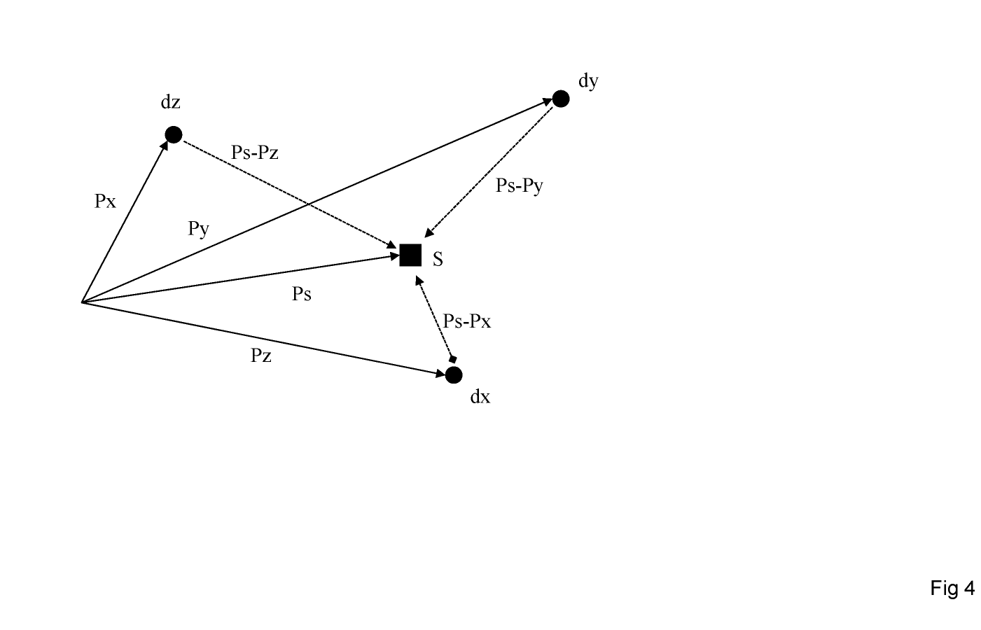

In the present arrangement example, as illustrated in FIG. 4, top three points that are close in terms of the contents are selected on the multi-dimensional vector space, and the position of S is determined.

The closeness of the contents between the additional information S and the respective items of information dᵢ in the population constituting the map is calculated. Three items of information dx, dy, and dz are sorted out in order of the closeness of the contents to the additional information S. Respective coordinates (vectors) on the map are denoted by Px, Py, and Pz. Assuming that indexes representing the closeness of the contents to the additional information S are Sx, Sy, and Sz, coordinates Ps that satisfy the following formula are position coordinates (vector) on the map at which the additional information S should be plotted.

|Ps−Px|:|Ps−Py|:|Ps−Pz|=Sx:Sy:Sz (Expression 4)

### (4) Fourth Arrangement Example

In the present arrangement example, the closest point in terms of the contents is regarded as a representative point on the multi-dimensional vector space, two close points are then selected on the map, and the position of S is determined. For example, the closeness of the contents between the additional information S to be plotted and the respective items of information dᵢ in the population A constituting the map is calculated. An item of information having the contents closest to those of the additional information S is denoted by dx, and position coordinates (vector) of dx on the map are denoted by Px. On the map, two items of information close to Px are denoted by dy and dz, and position coordinates of dy and dz are denoted by Py and Pz. Assuming that indexes representing the closeness of the contents between the additional information S and the items of information dx, dy, and dz are Sx, Sy, and Sz, coordinates Ps that satisfy the following formula are position coordinates (vector) on the map at which the additional information S should be plotted.

|Ps−Px|:|Ps−Py|:|Ps−Pz|=Sx:Sy:Sz (Expression 5)

### (5) Fifth Arrangement Example

In the present arrangement example, the additional information S is arranged at a gravity center of position coordinates of top N points that are close in terms of the contents on the map.

The closeness of the contents between the additional information S to be plotted and the respective items of information dᵢ in the population A constituting the map is calculated. N items of information are sorted out in order of the closeness of the contents from the additional information S. The gravity center of the position coordinates of the N items of information on the map is denoted by G_{N}. Coordinates of the gravity center G_{N} are position coordinates (vector) on the map at which the additional information S should be plotted.

### Third Embodiment

When advertisement information that is far in terms of the contents is plotted on the map, reliability of the map is reduced. In the present embodiment, therefore, unnatural additional information is excluded in the additional information arrangement procedure.

### (1) First Exclusion Example

In the present arrangement example, the closeness of the contents between the additional information S to be plotted and a group of items of information di constituting the map is calculated. An item of information having the contents closest to those of the additional information S is denoted by dx. An index representing the closeness of the contents to the additional information S is denoted by Sx.

N items of information (N is any number) are sorted out in order of the closeness of the contents from dx, and an item of information farthest from dx among the N items of information is denoted by dy. It is determined whether the additional information S is plotted on the map using an index Xy representing the closeness of the contents between dx and dy.

For example, S is plotted when Sx<Xy is satisfied, and S is not plotted when Sx>Xy is satisfied. Consequently, the unnatural advertisement information can be excluded.

### (2) Second Exclusion Example

In the present arrangement example, the closeness of the contents between the information S to be plotted and the group of items of information constituting the map is calculated. An item of information having the contents closest to those of the additional information S is denoted by dx. An index representing the closeness of the contents to the additional information S is denoted by Sx.

N items of information are sorted out in order of the closeness of the contents from dx, and an average of indexes Si of the N items of information di is denoted by S_{N}. It is determined whether the additional information S is plotted on the map using the average S_{N}.

For example, S is plotted when Sx<S_{N} is satisfied, and S is not plotted when Sx>S_{N} is satisfied. Consequently, the unnatural advertisement information can be excluded.

### (3) Third Exclusion Example

In the present arrangement example, a display aptitude threshold value D for the advertisement information is first determined in accordance with, for example, the closeness of the contents between two items of information adjacent to each other in terms of the contents in the group of items of information di constituting the population. The closeness of the contents between the additional information S and the group of items of information di constituting the map is calculated. An item of information having the contents closest to those of the additional information S is denoted by dx. An index representing the closeness of the contents to the additional information S is denoted by Sx.

In this case, S is plotted when Sx<D is satisfied, and S is not plotted when Sx>D is satisfied. Consequently, the unnatural advertisement information can be excluded.

### INDUSTRIAL APPLICABILITY

The present disclosure can be applied to the information and communication industry.

### REFERENCE SIGNS LIST

10 information display device
11 storage unit
12 information processing unit
121 map creation unit
122 additional information arrangement unit
123 display unit
124 additional information display unit
13 communication unit
20 storage
30 user terminal

1. An information display method comprising:
a map creation procedure of arranging, on a surface, an information population including arbitrary items of information based on closeness of contents of the items of information;
an additional information arrangement procedure of, responsive to acquiring additional information that is different from the information population including the arbitrary items of information, selecting, from the information population, a plurality of items of information having contents close to those of the additional information, calculating, from coordinates of the plurality of items of information on the surface, coordinates of the additional information on the surface based on closeness of the contents between the additional information and the plurality of items of information, and arranging the additional information at a position of the coordinates of the additional information on the surface;
a display procedure of displaying a map in which points representing the respective items of information included in the information population and a point representing the additional information are arranged on the surface; and
an additional information display procedure of, responsive to the point representing the additional information being selected on the map displayed in the display procedure, displaying the additional information, wherein
the procedures are executed by a computer in order.

2. The information display method according to claim 1, wherein
information related to the additional information is simultaneously displayed when the additional information is displayed in the additional information display procedure.

3. An information display device comprising:
a map creation unit configured to arrange, on a surface, an information population including arbitrary items of information based on closeness of contents of the items of information;
an additional information arrangement unit configured to, responsive to acquiring additional information that is different from the information population including the arbitrary items of information, select, from the information population, a plurality of items of information having contents close to those of the additional information, calculate, from coordinates of the plurality of items of information on the surface, coordinates of the additional information on the surface based on closeness of the contents between the additional information and the plurality of items of information, and arrange the additional information at a position of the coordinates of the additional information on the surface;
a display unit configured to display a map in which points representing the respective items of information included in the information population and a point representing the additional information are arranged on the surface; and
an additional information display unit configured to, responsive to the point representing the additional information being selected on the map, display the additional information.
